(19) United States
(12) Patent Application Publication
(10) Pub. No.: US 2003/0097332 A1
(43) Pub. Date: May 22, 2003

(54) Machine and method for the payment of a bill at a remote location

(76) Inventors: Andrea Golasinski, League City, TX (US); Robert Preston Lynch, Houston, TX (US); John A. Foster, Sugarland, TX (US); Robert Munkatchy, Houston, TX (US); Brett Passmore, Houston, TX (US)

Correspondence Address: Beirne, Maynard & Parsons, L.L.P., 25th Floor, Wells Fargo Tower, 1300 Post Oak Boulevard, Houston, TX, 77056, US

(21) Appl. No.: 09/833,275

(22) Filed: Apr. 11, 2001

(51) Int. Cl. G06F 17/60

(52) U.S. Cl. 705/40

(57) ABSTRACT

A machine and method electronically process data pertaining to a utility or other bill at a remote station or location, such as a kiosk. The data is transmitted in real time or batch for credit to the account of the payor. If the payment is made by a financial institution check, the machine will process the check without a signature or identification on the check of the amount to be paid and will convert the check to an ACH transaction. The machine includes a programmed computer operating in combination with a touch-type video monitor for prompting the operator via audio and video signals pertaining to operation of the various steps of the machine.

### BACKGROUND OF THE INVENTION

(1) Field of the Invention

The present invention relates to an electronic, self contained, automated bill payment machine and method of use incorporating real time or batch processing of the payment.

(2) Description of the Prior Art

In many instances, bills, such as utility bills, credit card payments, bills for subscriptions for newspapers, periodicals and the like are paid by mailing checks or by credit card payments and even electronic fund transfers from a bank or other financial institution authorized by the recipient of the bill or the “payor”. One common method of paying utility bills is the presentment of a bill by a customer to a clerk or teller at a grocery store or other consumer environment. The bill is paid with cash, check or by means of a credit or debit card. The bill may contain scan line information or information in another format which identifies the customer's account number and gives data about the amounts owed, the due date, the nature of the utility, and the like. The teller or the clerk at the grocery or other store then scans the scan line information with a scanner which reads the information into a computer and the computer computes the amount due with a clerk manually inputting the amount paid. Alternatively, of course, these steps may be, and frequently are, accomplished by annual means without the use of the computer. The payor's account is updated with the payment information and the payment is credited to the account of the particular utility or other provider.

This system has many obvious disadvantages, one being that it is very labor-intensive and costly for the issuers, as well as the grocery and other stores which collect the payments. Another, equally onerous disadvantage is that the customers often wait in long lines to pay their bills, and can pay them only when tellers or clerks are on duty.

The present invention addresses the problems of the prior art generally as above described.

### BRIEF DESCRIPTION OF THE DRAWINGS

FIG. 1 is a schematic perspective illustration of the machine of the present invention, in kiosk format.

FIGS. 2A and 2B together constitute a logic flow chart of the various method steps incorporated into the machine of the present invention.

### SUMMARY OF THE INVENTION

The present invention provides a machine for the payment in real time or batch of a bill. As used herein “bill” means a document in the hand of an operator which requires financial satisfaction. Typically, the bill will be issued and transmitted to a person owing the bill, hereinafter referred to as a “payor” by an entity referred to as a “billor”. The payor may be an individual or a business, governmental or educational entity. The billor typically will be a utility company, but may be any other type of business entity, such as a retail store, outlet, service provider, such as a plumber, electrician, or the like.

The machine comprises a support structure which is preferably in the form of a body or base having a number of faces in the form of a “kiosk” structure. Electronic means within the support structure are provided for transmitting data in real time or batch such as through a dedicated telephone line, or the like to and from the machine pertaining to the payment of the bill. Means are secured to the support structure for electronically scanning the bill to identify and retrieve predeterminable data on the bill such as the name of the billor, the name of the payor, the amount of the bill, the type of bill, the frequency of the bill, whether or not partial payment is accepted, and the like. A microprocessor is incorporated into a computer which includes a computer program for the operation of the computer to store and retrieve data pertaining to the payment of the bill and for generating commands to the machine for implementing the various steps in the operation of the machine and the practice of the method. Means are provided in the structure for optically scanning a check issued by a financial institution, such as a bank, which is presented on behalf of the payor by the human operator of the machine for payment of the bill. Video monitor means, preferably a touch-sensitive screen, is provided for prompting and confirming various commands and steps in the operation of the machine and the method. Means are also provided for generating on the screen a video instruction image for operation of the screen by the operator, as, for example, the image of a human or the like. Means are also provided for generating an audio signal in a preselected language, i.e., English or other language, concurrently with the video instruction image generated on the screen, which may also be the touch screen or, alternatively, a separate screen. A computer is programmed for computing data received through the optical reader and controlling the screen and the audio signal. The computer also applies, as programmed, the payment of the bill and electronically transmits data pertaining to the payment of the bill in real time or batch to the billor and, if a check is used for full or partial payment of the bill, to the financial institution to generate a real time or batch ACH transaction debit to the account of the payor.

In one embodiment of the invention, a method for payment by the operator for use of the computer system is provided in which a check may be used to initiate full or part payment of the bill. The check is not required to be either signed or filled in, such as by filling in the amount of the check and the name of the payee along the line which typically will state “pay to the order of”. The machine and method converts this to a self-service “ACH transaction”. As used in the specification and in the claims, the phrase “ACH TRANSACTION” means the conversion of a conventional check drawn on a financial institution and converting it into an electronic check for payment through means of an automated banking clearing house (ACH). An electronic check is an electronic payment instruction which is digitally signed by the payor. Typically, a payor issues an electronic check with a digital signature to the payee. The payee endorses the check by providing a digital signature to the check which then passes the endorsed check electronically to the payee's bank. The payee's bank verifies the syntax of the check to make sure that it is correct, and also verifies the signature of the payee on the check. Thereafter, the payee bank converts the check into a format which is suitable for clearing with the Automatic Clearing House (ACH) of the Federal Reserve Net Settlement System. The payee bank issues a formatted ACH debit instruction containing the check to the ACH. At the designated time of day, the ACH performs the check settlements and eventually performs a funds transfer by sending a credit to the payee's bank and a debit to the payee institution. As contemplated herein, an ACH transaction converts an unsigned conventional check and the amount of the check not inserted on the check into a scanner and the data therefrom is processed and converted into an ACH transaction.

In actual commercial operation, the “payor” is a retail consumer who is not a professional computer operator. The machine and the method permit self-service bill payment by the operator/consumer. The service is provided 24 hours per day, 7 days per week, without the assistance of an on-site trained operator. Assistance to the unskilled operator is provided by a call center professional who can remotely assist in completing the transaction.

The machine and method also permit the remote acceptance of cash by the computer from the payor. It provides money reconciliation for the retailer/host to secure the control and reconciliation over the cash accepted by the machine. It then provides for the ACH sweep of the cash depository account and automatic conversion of cash to electronic ACH to permit transfer of the funds.

An SQL data base located on the support structure runs independently of the central computer even if communications between the central computer and the machine are interrupted. The data base is periodically replicated to the central computer when communications are working and the data is automatically uploaded to the central machine for final processing.

### DESCRIPTION OF THE PREFERRED EMBODIMENTS

The computer of the machine includes a micro processor which may be any one of a number of commercially available integrated circuit micro processors, such as Compaq® (a registered trademark of Compaq Incorporated). It may be battery-powered or backed-up or may operate off of alternating current source and will have a random access memory (“RAM”) and a read-only memory (“ROM”) and is programmed as herein described.

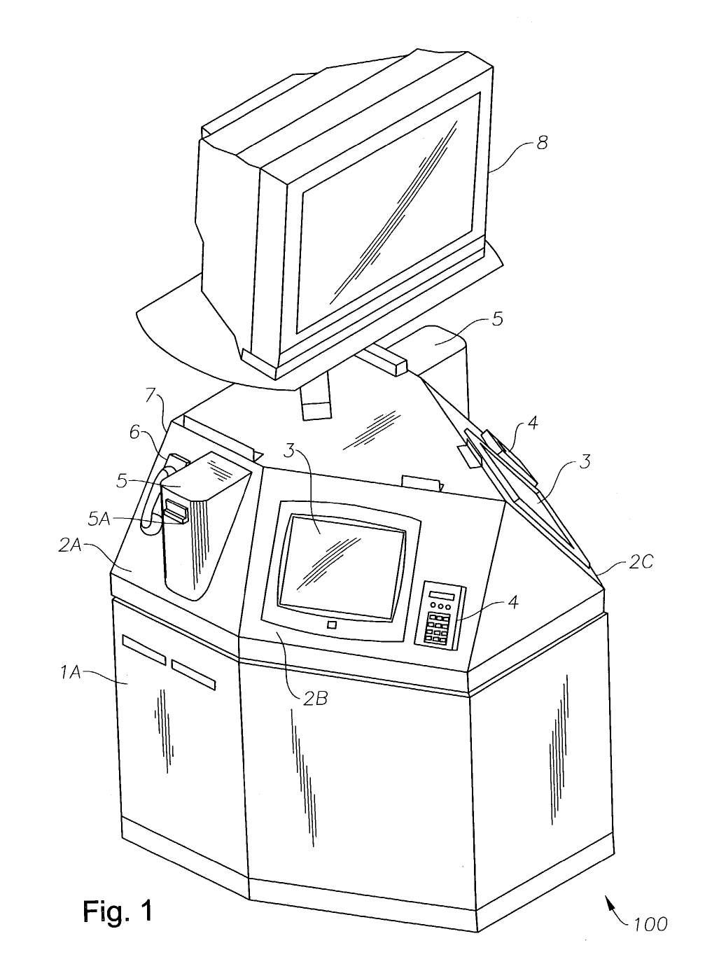

Now with first reference to FIG. 1, there is shown a perspective illustration of the machine 100 of the present invention in kiosk format for practice of the method. As shown in FIG. 1, a base or lower kiosk housing 1 receives a companion upper kiosk housing 2 which, as shown, has a number of faces or off-sets 2a, 2b, and 2c. The faces 2b and 2c, as will be shown, are duplicative with respect to receipt of operational components.

Each of the faces 2b, 2c contain a touch screen monitor of conventional form and readily available from a number of commercial sources. A “touch screen” is an input device which is used to acquire data for the computer through the computer program for the control of functions in the machine and method. A “touch” on a touch screen means that the touch screen senses the presence of an object, such as a tip of a finger of a human operator or another object, for example, a stylist, at and/or at a small distance from an active surface area (“field”) of the touch screen. An output signal which, in general, is either an electrical, i.e. optical, signal is generated from the touch screen. The output signal may include information which is directly dependent on the position of the “touch” on the touch screen.

The active surface area on the screen may be arranged into predetermined regions and, when a particular region is “touched”, the output signal may then depend on a unique identification code which refers to that particular region of the screen. An input component including the touch screen performs data processing on the output signal from the touch screen to provide a signal which is compatible with a predetermined format, as further described herein. Typical of such touch screen technology is as disclosed in U.S. Pat. No. 4,550,211 to Mabusth, entitled “Touch Sensitive Control Device.”

Each of the faces 2b, 2c have in proximity to the touch screens 3 an electronic key pad 4 for input of various numerals required for identification of billing accounts, check numbers, and other manual insertion of data for use by the computer as hereinafter described.

An optical check reader 5 is provided on check face 2a and on a face (not shown) adjacent face 2c for introduction through a window 5a of a check to be optically scanned during the payment process. Preferably, the optical scanner for reading of checks is as manufactured by RDM Corporation of Canada.

A telephone hand set 6 is also provided on face 2a in the event that the customer desires to communicate with a service assistant or operator for questions about the operation of the apparatus or method or to report errors or malfunctions.

A bill acceptor 7 also is provided on panel surface 2a for the insertion of paper currency to determine the genuineness of the currency as well its amount for purposes of calculating correct payment of the utility bill. The currency is moved over a path along which various optical, magnetic or edge sensing tests are performed. Such devices are commercially available from a number of sources, or well known to those skilled in the art and may be selected from a number of varying components. Typical of such prior art devices is that as generally disclosed in U.S. Pat. No. 4,470,496 entitled “Control Circuit for Bill and Coin Changer,” to Steiner. Such devices may be provided in a component which is programmed to dispense a cash voucher for the inserted paper currency when the amount of the paper currency and/or the check exceed the amount of the bill or bills to be paid.

A series of printers 8 are disposed on the face 1a of the housing 1 for printing of receipts and other information reflecting the payment transaction occurring through the apparatus.

As shown, the kiosk incorporating the present apparatus has at its top a television 9 which is controlled by a third computer within the support structure. This computer may be operated with a number of operating software systems, such as Windows 2000 and MSInternet Explorer. The computer also contains an SQL database which keeps track of the advertisements that are being shown via digital video on the television 9. The advertisers have the ability to connect to central host computer systems via the web which contains a database of demographic profiles for the neighborhoods where each of the machines are located. The advertiser is able to select the demographic criteria which it desires, such as income, race, language, housing value, sex, geographic region and many other categories which the advertiser desires to target with the advertisement. The advertiser is then permitted to rank and select the machines with locations most like the preferred or targeted demographic profile requirements. The advertiser then binds an electronic contract for the particular machines on which it wishes to advertise and selects the time slots and number of times it wishes to run the advertisement on the television 9. The advertiser then produces the advertisement to the technical specification and downloads the advertisement to a central computer system joining a plurality of the self-service machines. The advertisement is then electronically “pushed” out to the individual, selective machines.

The software preferably utilized to implement the present invention may be any one of a machine code, such as visual basic, or Microsoft ASP. The logic and sub-routines utilized to form the machinery and method disclosed herein is set forth below:

[image]

The present invention contemplates a variety of steps which may be all inclusive or utilized on a selective basis to implement the method. The machine and the method may be designed so that the operator initially selects the language which will be utilized on instructions appearing on the video screen 3 and in the audio companion instructions also appearing on the video screen 3. The operator simply touches the touch screen monitor 3 at the appropriate location to designate a language, such as English, Spanish, French, or the like. Thereafter, the operator is asked if the payment is to be for one bill or a number of bills. If the customer elects to process only one bill for payment, the customer chooses by application through the touch screen monitor 3 at the appropriate location the “BILL PAY” identification. Alternatively, if the customer would like to pay multiple bills, an indicator on the touch screen monitor 3, such as “COMPLEX” or “MULTI-BILLS” will appear on the screen and the operator applies a finger or otherwise touches the appropriate location on the screen 3 to reflect his/her selection.

The machine and method of the present invention are preferably designed to charge the operator a nominal fee for the electronic payment process. Accordingly, the customer is asked to understand and agree to the terms of the operation of the machine and the practice of the method, including agreement to the payment of a service charge by touching the “AGREE” field on the screen 3. Alternatively, the customer may touch “CANCEL” to return to the “MAIN MENU” reflected on the screen.

The next sequence of steps in the operation of the machine and the practice of the method is for the operator to select a utility or other company, sometimes referred to as “billor”, to whom payment is to be made. Accordingly, the identification of the utility or other company will appear on the screen 3 and the operator will touch the identification of such company at the appropriate location on the screen 3.

After the billor has been selected by the operator, the bill is scanned through the bill scanner 6 after an instruction to do so is reflected on the screen 3 concurrently and preferably with a similar audio instruction.

The machine and method of the present invention contemplate providing a discount of the service charge for senior citizens, disabled or other preselected groups of individuals or entities under an obligation to satisfy payment of bills by the billors (such people and the group sometimes referred to as “payors”). For example, if a discount is to be given to a senior citizen, a query regarding same appears on the screen 3 and confirmed through audio companion signal to the operator for an inquiry to confirm “senior citizen” status. The operator then touches the appropriate location on the screen to confirm “YES” or “NO”. Verification of senior citizen status is established by insertion by the operator of a driver's license or other personal identification in the card reader portion of the key pad on the optical check reader 5. Thereafter, the computer in the machine calculates the amount due from data extracted from the bill inserted into the machine, and the operator is asked on the screen 3 how payment will be made. For example, “CASH”, “CASH/CHECK”, “CHECK”, options may appear on the screen 3 and the operator may touch the appropriate location for manner of payment.

If cash payment is selected, the total balance is displayed on the screen 3 and the appropriate amount of cash is deposited by the operator into the bill acceptor 6. The bill acceptor 6 will extract data therefrom and the computer will calculate and confirm complete, exact payment, or, if over payment, will generate an instruction to the bill acceptor 6 to generate a cash voucher, as required. Alternatively, the machine will indicate on the touch screen 3 an excess of money which may be applied as either a credit against future bills of the billor or payment of another bill by the billor or another billor in subsequent operation of the machine. Alternatively, if change is due, a “cash” voucher may be issued by query to the operator on the video screen 3 and confirmation by touching the appropriate location on the screen. A credit voucher will then be generated by the machine. Alternatively, over-payment of the bill may be either applied directly to the bill by touching the appropriate location in response to a query appearing on the screen 3 or, alternatively, confirming by touch to the screen 3 application of the over-payment to the next utility bill to be paid on the machine.

If the check option is desired by the operator for payment of all or part of the bill, the query appears on the screen 3 and confirmation thereof is indicated by the operator touching the appropriate location on the screen. The check is then scanned as previously described through introduction of the check into the reader 5.

Another feature of the present invention is the ability to scan and process the check used to pay a bill without the necessity of the person or entity owing the bill, or the operator of the machine being required to actually sign the check and/or fill in the amount of the check. The check is scanned and processed as an ACH transaction. If the operator desires to pay the bill by use of a check, the computer generates a graphics and video instruction to the operator that it is not necessary to fill out the check or sign it. The customer then is instructed to introduce the check through the scanner and it is returned to the customer. An image of the check is recorded in the data base in the computer and picture of the customer is taken. The customer is then asked for authorization to use the driver's license or other identification document of the customer for identification purposes and the driver's license is then scanned for information thereon. The customer is then asked to confirm through touch on the touch screen in an appropriate location to confirm that the customer is an authorized Signor on the checking account. A manual confirmation by the customer of the amount to be paid through the check may be made by introducing the monetary amount of the check by application of fingers to the key pad. The ACH transaction is then processed in batch or real time through an electronic banking ACH process for deduction of the amount from the customer's checking account as indicated for the transaction. If a check is used for payment regardless of whether or not it is signed and/or filled out, proper identification of the operator is prompted by the operator confirming permission to use a driver's license by response to a query appearing on the screen 3. The operator touches the “OK TO USE DRIVERS LICENSE” or other appropriate wording, by touch to corresponding field on the screen 3. The drivers license or other document of the operator is then scanned and information is stored in the computer thereon. The computer will then read a magnetic strip or the like on the back of the drivers license or other identification card. Confirmation of authorization to sign on the checking account reflected on the check is also processed through the machine. The customer is asked to so confirm by appropriate message appearing on the touch screen 3 and the customer is prompted to apply touch in the appropriate location to a message reading “CONFIRM” or the like.

The full amount of the total bill payment is displayed on the screen 3 after processing through the computer. If the customer wishes to pay the full amount of the bill through check, the customer will press the field “PAY FULL” appearing on the screen 3.

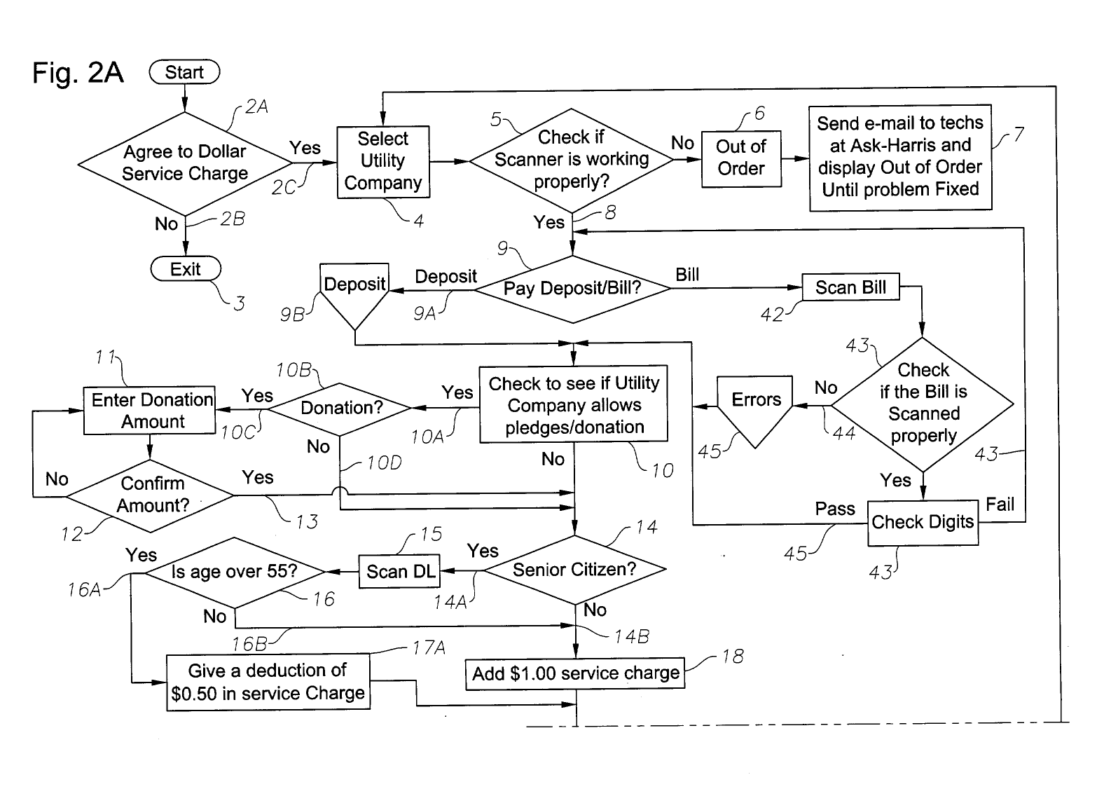

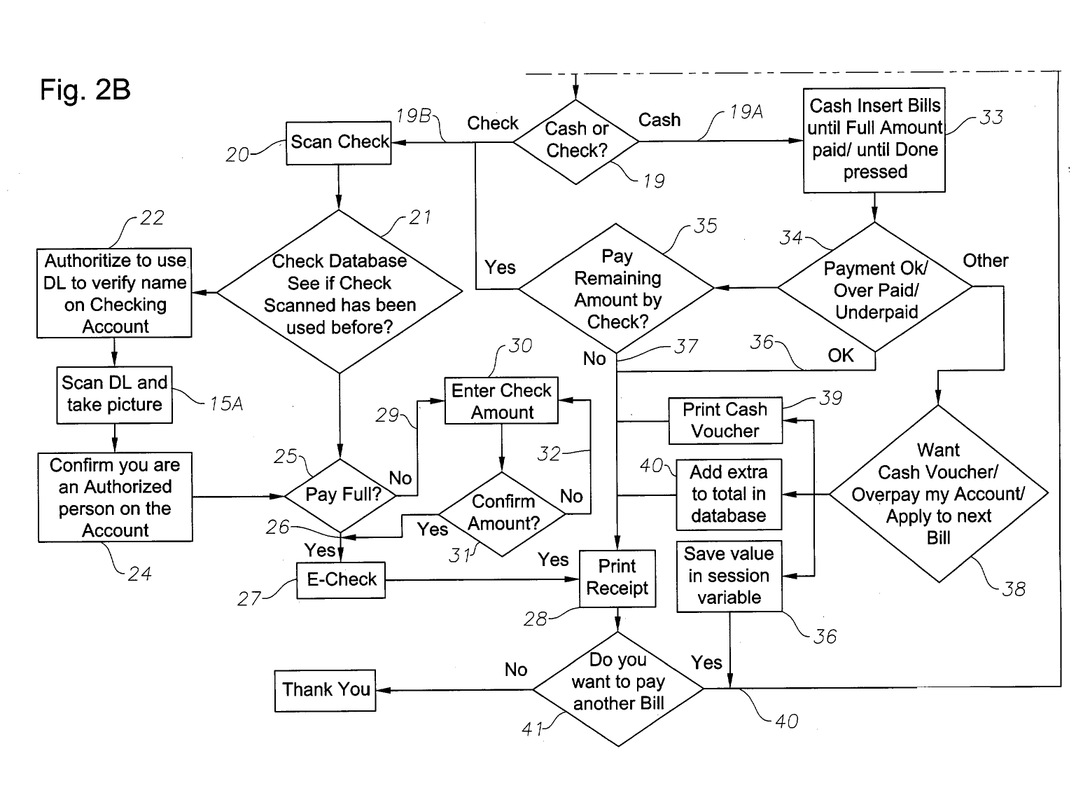

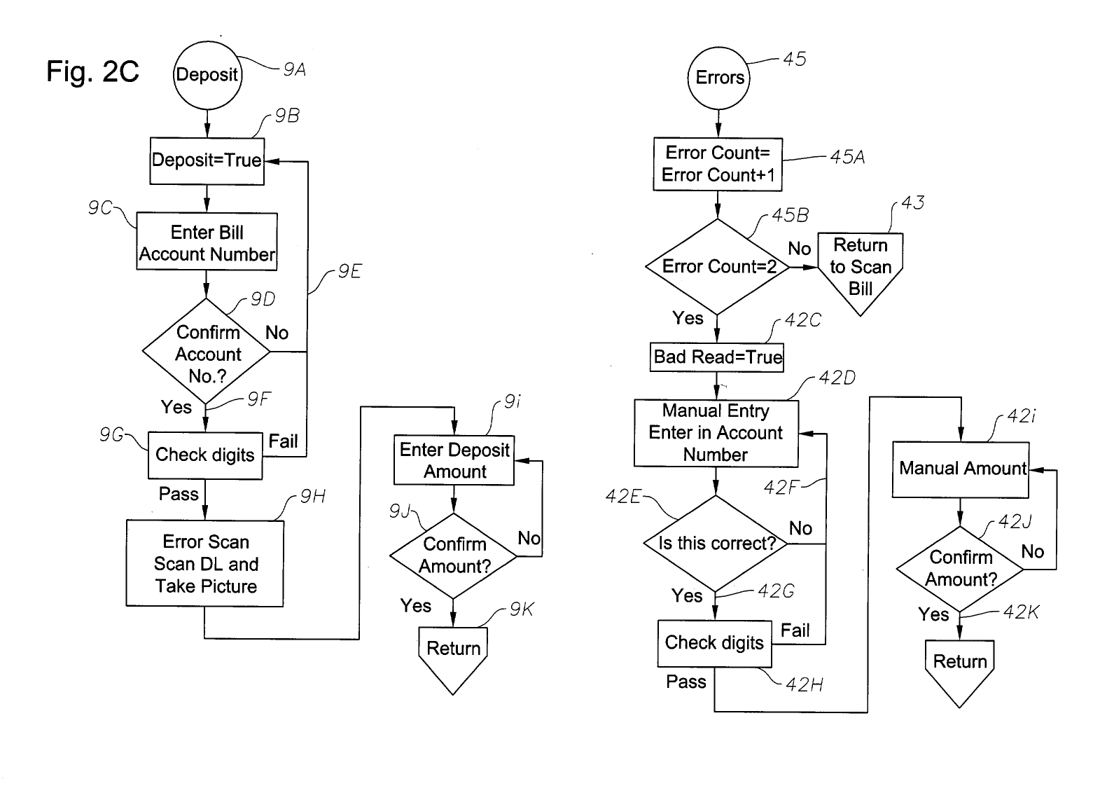

The machine and method will accommodate partial payment of the full amount displayed by check upon so indicating by the customer in the appropriate field on the screen 3. The checking account information extracted by the machine, including the amount paid on the bill is transmitted in real time or batch concurrently from the financial institution issuing the check and holding the account of the operator to the account of the payor at the billor. The check then is returned through the optical check reader 5 to the customer and a receipt is generated by the computer and printed on paper through the printer 8 in the machine. Alternatively, a cash voucher may be issued through the printer 8 or the amount can be treated as a “credit” for use by the operator in paying another bill. If another bill is desired to be paid, the process is repeated. Now with reference to the logic flow chart of FIGS. 2A and 2B, the human operator or customer initiates bill payment by pressing the start button 1 on the face of the kiosk machine 100 and is asked via a message on the video screen blank and/or via audio message if the customer agrees to a service charge of a specified amount, for example $1, at message 2A. Pressing of the “no” (or “agree”) button 2B, (or failure to press the “yes” button 2C) within a specified short time, say, 5 seconds, will cause movement to the exit field 3 and shut down of the service function to the operator. An affirmation of the service charge 2A through activation of the “yes” button 2C will open to the operator the selection of the utility company 4 either by pressing in an appropriate place on the screen corresponding to an identification of the selected utility, by pressing a selection button, or the like. The machine next tests if the electronic bill scanner is properly working in field 5. If the scanner is not working properly an “out of order” message 6 is generated and an alert message is sent via email or other signal and an “out of order” is displayed on the video screen in function 7.

If the scanner check step 5 indicates proper functioning 8, the actual bill payment functions are initiated at function 9. As shown in FIG. 2A, the payment step may be that of actually paying a bill of a utility or making a deposit for security or as a pre-payment against a future bill. The operator is prompted at step 9 to select either the “deposit” or the “bill” payment option by touching an appropriate place on the video screen or by pressing a button or otherwise. If the deposit sub-function 9B is selected, the machine then determines if the selected utility company allows pledges or donations at function 10. If this answer is affirmative 10A, the operator is asked if he/she desires to make such donation at 10B. If the operator responds affirmatively at 10C, the operator then enters on the key pad or by touching the video screen the amount of the donation 11. However, if the operator elects not to make a donation, the “no” button 10D is pressed, or the equivalent position on the video screen is contacted by the operator to lead to the next operation, discussed below.

If no donation amount is entered by the customer at function 10D, the operator is prompted via audio/video message to confirm the amount of the donation through step 12.

After the amount is confirmed at 13, the customer is asked if he/she is a senior citizen 14. This question is also asked as the next step in the event that the utility or other billor does not accept pledges or donations at 10 or if the operator does not wish to make a donation 10D.

If the operator answers affirmatively that he/she is a senior citizen 14A, the operator is asked to apply his/her driver's license or other identification document to an optical or similar scanner 15. If the results of the scanning of the driver's license at 15 indicates that the age of the operator is over a specified amount, such as 55 years at step 16, by affirmative answer “yes” 16A, a deduction of a specified amount of the service charge for example, 50¢ is activated at 17A. If the age requirement for the service charge deduction is not satisfied at 16B, i.e., the operator is not a senior citizen 14B, the computer program will cause the machine to automatically add a service charge in a specified amount, for example, $1.00 at step 18. Alternatively, if the customer is a senor citizen and the driver's license scan confirms that the customer is over a specified age, the deduction at step 17A is made after application of the service charge at 18.

The next grouping of steps in the operation of the present bill payment method and machine involves the collection and transfer of funds for payment of the selected bill of the utility or other company. The operator is asked through step 19 whether payment will be made through cash 19A or check 19B. If the operator presses the appropriate button on the key pad or touches the appropriate field in the video screen for payment by check 19B, the check is scanned at 20 through the appropriate scanner. The data base in the computer is then checked at field 21 to see if the check has been previously utilized or processed for payment at another location, such as through direct processing or the like. The name on the check reflected through the check scan at 20 is compared against the name on the driver's license scanned at 15 to verify the name on the checking account reflected on the check at step and field 22. The driver's license is again scanned at 15A, as in 15 and a photograph of the operator is digitally taken through a digitized photo reproduction means also at 15A. Confirmation that the operator is an authorized person on the account is made at 24, such as by communication and confirmation through the bank or other financial institution (not shown).

The operator then is asked at 25 if either full or partial payment of the bill is to be made. If full payment is to be made by indication of “yes” at 26, the signal from the check scan function 20 is retained at 27 and a receipt is printed and received by the operator at 28. However, if the customer indicates only partial payment of the bill at 29, the amount of the check is entered at 30 and confirmed at 31. This step is repeated through repeat function 32 until the check amount 30 is confirmed.

Returning to the determination of whether payment is to be made by cash or check, at function 19, if the operator indicates through the key pad or touches the appropriate point on the video screen, that the payment is to be made through cash, 19A, the cash is inserted through the cash receiving device at 23. The operator then confirms full cash payment by pressing “done” on the key board or by touching such position on the video screen. The device then confirms either correct payment, over payment, or under payment at function 34. If the bill has been under paid at 34, the operator is asked to either insert additional money at 33 or may pay the difference at 35 through check, in which case, the check is scanned at 20 and the steps are followed as though complete payment had been made through check. If correct payment has been made at 36, a receipt for the amount is made through step 28. Likewise, if the operator elects not to pay the remaining amount by check at step 35, through 37, the final receipt is printed at 28 for the amount of the payment, even though it is less than the full amount owed for the bill to be paid.

If the operator has overpaid the bill through an indication at field 34, the operator is prompted to select a cash voucher for future usage or to apply the amount of the overpayment to the next bill at step 38. If a “cash voucher” is indicated, the cash voucher is printed at 39. Alternatively, the amount of the over payment is added to the total in the data base at 40. In either event of 39 or 40, a receipt is then printed at 28. Alternatively, an overpayment indicated at 34 may be applied to the next bill to be paid through the system at 36, in which event the customer indicates a desire to pay another bill at 37 and the bill payment cycle is continued at 41 by selecting the second utility company at 4 and repeating the steps described above.

Returning to the step of either depositing an amount or paying a bill at step 9, if the bill function is selected, the bill is scanned at 42 and checked for proper scanning through 43. If it has not been properly scanned, 44, any scanning errors are identified and corrected at 42, and the procedure continues through step 10 to determine allowance of pledges or donations. If the utility bill is properly scanned at 42, the account digits are checked and verified at 43. If the digits cannot be verified at 43, a “fail”, 43, is indicated, and the process is repeated through steps 9 and 43. If the digits are checked and verified, 45, step 10 is initiated to determine if the utility company allows pledges and donations and the sub-procedures described above, are followed.

Turning, now, to FIG. 2B, the deposit step 9A is further detailed. The deposit is made at 9B and the bill account number is entered by the operator on the key pad or by application of touch to the proper field on the video screen at 9C. The account number is confirmed by the computer at 9D. If there is no confirmation, 9E, the deposit cycle is repeated, 9B. If the account number is confirmed, 9F, the check digits are confirmed 9G and, if negative, the deposit cycle 9B is repeated. If the check digits pass, the driver's license is scanned and a photo image on the driver's license is extracted at step 9H. The deposit amount then is entered at 91 and confirmed 9J. The deposit amount is re-entered if there is no confirmation of the amount. If the amount is confirmed, the sub-step is terminated at 9K.

FIG. 2B also depicts the steps and sub-steps for determining the errors 42 in properly scanning the bill through step 40. If errors 42 are determined, the computer checks for error count in steps 42A and 42B. If no errors are determined, the system will return to the scan bill step 40. If an error has been determined at 42A or 42B, the computer will indicate a “bad” read, 42C on the video terminal and the customer will be asked to enter the account number manually 42D. The number is then reflected on the video screen with a “is this correct?” query, 42E, and if not, 42F, the number is again manually entered at 42D. If the correct number is established, 42G, the check digits are confirmed at 42H and if not confirmed, the number is again manually re-entered at 42D. The manual amount, 42I, is confirmed at 42J until passed at 42K, at which time return is established to sub-step 40 and passage through check digits 42, 44.

### Magnetic Ink Character Recognition Component

Magnetic ink character recognition (“MICR”) is used to scan checks which are tendered by the customer for payment of bills. MICR involves two fundamental steps in the recognition process. First, the magnetizable ink forming a recognizable character must be magnetized to create a magnetic image of the character. Secondly, the magnetic image must be sensed or read and identified as a character in accordance with pattern recognition techniques, well known to those skilled in the art. The character field is generally divided into a plurality of discrete, vertical lines or segments, each line or segment being individually magnetized. A common magnetization technique is to apply a sinusoidally-varying magnetic field over the character, where each sinusoidal cycle is intended to magnetize one discrete segment of the character. This technique has been shown by experience to facilitate the reading and recognition of the character.

When the check bearing in-coded characters of magnetizable ink is magnetized or written upon, it is transported past a write station having a write head that generates the sinusoidally varying magnetic field. The transportation of the check past the written station is generally by mechanical means, such as a read drum having an outer circumferential edge that grips the document and rotationally transports it past both the right and read stations. It is important that the mechanical transport means be driven at a uniform, consistent velocity to correlate the position of the character field in the write station with the timed actuation of the write head for properly spaced magnetization to occur. Such systems are well known to those skilled in the art of electronic reading of characters on legal instruments, such as checks, and the like. The reader is directed to U.S. Pat. No. 4,087,789 for a more detailed description of typical prior art apparatuses. Such apparatuses are commercially available through a number of corporations, such as Burroughs Corporation, of Detroit, Mich.

In operation, the MICR units include the magnetizing head, a magnetic read head and circuitry for recognition of the characters. In operation, the check is passed over the magnetized head, which magnetizes the magnetic particles in the ink, and over the read head, which detects the magnetization of the ink, and over the read head, which detects the magnetization of the magnetized particles and transmits representative signals to the recognition circuitry. Frequently, a drive mechanism is provided to drive the check through a channel in the reader pass the magnetizing and read heads. In many commercial embodiments, the channel extends the length of the reader. One end of the check is inserted into one end of the channel and is driven the length of the reader along the channel until the opposite end of the check exits the opposite end of the channel, where it can be retrieved by the customer.

Optical character readers may also be used to read the information encoded on the checks. Such readers incorporate an optical character read head and circuitry for recognition of the optical characters. Optical characters typically conform to a predetermined specification such as ANSI-X-3.17.

The present invention contemplates usage by the customer of credit or bank cards in lieu of cash or checks. Such cards contain information encoded on a magnetic strip on one side of the card. The strips typically include up to 3 tracks. Information is then coded on the tracks in accordance with certain standards, such as ANSI-X-4.16 and IS03554, specifications for magnetic strip inclosing. Track one has been developed for use by the air transportation industry, track two for the banking industry and track three for the thrift industry. Magnetic strip readers include a magnetic strip read head and circuitry for recognition of the encoded information. In operation, the magnetic strip of the credit or bank card is passed over the read head.

Magnetic strip readers are used in retail establishments for processing purchases made with a credit or bank card. Typically, these devices are located close to a cash register and include a slot or channel, open at both ends, through which a sales clerk at the point of sale slides or “swipes” the card. Many commercial devices include a MICR reader and a magnetic strip reader combined as a single unit. However, the electronic components of the MICR reader must be sufficiently far away from the magnetic strip reader to avoid erasing the magnetic strip data on a card passing through the magnetic strip slot. The area around both ends of the devise must be kept relatively free of other objects to provide unrestricted access to the slots or channels, particularly for checks, which comprise of paper medium which are easily bent or torn. Accordingly, when a combined magnetic strip reader and a MICR reader are embodied in the machine and method of the present invention, it should be compact for accommodation into a comparatively small area. Typical of the commercially available combined readers is the SCAN TEAM™® 8300 of Raco Industries.

Although the invention has been described in terms of specified embodiments which are set forth in detail, it should be understood that this is by illustration only that the invention is not necessarily limited thereto, since alternative embodiments and operating techniques will become apparent to those skilled in the art in view of the disclosure. Accordingly, modifications are contemplated which can be made without departing from the spirit of the described invention.

What is claimed and desired to be secured by Letters Patent is:

1. A machine for the payment of a bill of a billor owed by a payor, said machine comprising:
(1) a support structure;
(2) electronic means within said support structure for transmitting data to and pertaining to the payment of said bill to the payor;
(3) means secured to said support structure for electronically scanning said bill to identify and retrieve predeterminable data on the bill;
(4) a microprocessor;
(5) means carried by said structure for optically scanning and accepting a check presented on behalf of the payor for payment of the bill;
(6) video monitor means including a screen responsive to touch initiated by a human operator;
(7) means for generating on said screen a video instruction image for operation of the machine by the operator;
(8) means for generating an audio signal in a pre-selected language concurrently with the video instruction image;
(9) a computer program means within said microprocessor in said structure for operating said computer to store data pertaining to said payment; for generating commands for processing the payment for computing data received through the optical scanning means, for controlling the video monitor, the video instruction, the means for generating the audio signal, and for applying the payment of said bill and electronically transmitting data pertaining to said payment to the billor.

2. The machine of claim 1 wherein the means for electronically scanning said bill further comprises means for identification of the billor, identification of the bill, the amount owed for the bill, and data pertaining to the billor.

3. The machine of claim 1 wherein the data is transmitted in real time.

4. The machine of claim 1 wherein a plurality of video monitor screens are provided and carried by the support structure, and said computer program enables display on at least one of said video monitor means if another of said video monitor screens is inoperable.

5. A machine for the payment of a bill of a billor owed by a payor, said machine comprised:
(1) a support structure;
(2) electronic means within said support structure for transmitting data to and from said machine pertaining to the payment of said bill;
(3) means secured to said support structure for electronically scanning said bill to identify and retrieve predeterminable data on the bill;
(4) a computer program means within a computer in said structure for operating said computer to store retrieved data pertaining to said payment and for generating commands to the machine for processing the payment;
(5) means carried by said structure for optically scanning legal currency presented on behalf of the payor for payment of the bill;
(6) video monitor means including a screen responsive to touch initiated by a human operator;
(7) means for generating on said screen a video instruction image for operation of the machine by the operator;
(8) means for generating an audio signal in a pre-selected language concurrently with the video instruction image; and
(9) a computer programmed for computing data received through the optical reader, controlling the screen and the audio signal, applying the payment of said bill and electronically transmitting data pertaining to said payment to the billor.

6. The machine of claim 5 further including means for counting said currency and identifying the total of individual denominations of said currency optically scanned and accepted by said optically scanning means.

7. The machine of claim 1 further including; means at a remote location relative to said machine for electronically overriding and controlling the operation of the machine at least during payment of said bill.

8. The machine of claim 1 or claim 5 comprising a computer program means for storage of data per ______ at least one bill payment and for transmission of data pertaining to each said payment subsequent to loss and re-establishment of an electronic communications line between the machine and a central location.

9. A method for the payment by an operator by the use of a machine, including a programmed computer system at a location remote from a billor of at least one bill issued by said billor, through the use of a check drawn on an account of a financial institution and for electronically storing and transmitting data pertaining to the payment of the bill from said computer to at least the billor, comprising the steps of:
(a) advising the operator of the machine incorporating said computer, through at least one of video and audio display, that it is not necessary to fill out the amount of said check or apply a signature to said check;
(b) prompting the operator to introduce the check into the bill payment machine;
(c) optically scanning said check for retrieval of data contained on the check;
(d) transmitting and storing the data retrieved from the check into the computer;
(e) recording an image of the check and transmitting the image into the data base of the computer for storage;
(f) prompting the operator to manually enter into the machine the monetary amount of the check;
(g) returning the check to the operator;
(h) digitally recording an image of the operator and transmitting said image to said computer for storage;
(i) verifying the identification of the operator by optically scanning an identification document and storing predeterminable information thereon in said computer;
(j) prompting the operator to confirm through the machine that the operator is an authorized signor of said account identified on said check; and
(k) electronically transmitting data from the check to said financial institution for a deduction of the monetary amount of the check entered into the machine by the operator from said account.

10. A method for the payment by an operator by the use of a computer system at a location remote from a billor of at least one bill issued by said billor, through the use of a check drawn on an account of a financial institution and for electronically transmitting data pertaining to the payment of the bill from said computer to at least the billor, comprising the steps of:
(a) advising the operator of a bill payment machine incorporating said computer, through at least one of video and audio display, that it is not necessary to fill out the amount of said check or apply a signature to said check;
(b) prompting the operator to introduce the check into the bill payment machine;
(c) optically scanning said check for retrieval of data contained on the check;
(d) transmitting the data retrieved from the check into the computer;
(e) recording an image of the check and transmitting the image into the data base of the computer for storage;
(f) returning the check to the operator;
(g) digitally recording an image of the operator and transmitting said image in said computer for storage;
(h) verifying the identification of the operator by optically scanning an identification document and storing predeterminable information thereon in said computer;
(i) prompting the operator to confirm through the machine that the operator is an authorized Signor of said account identified on said check;
(j) electronically transmitting data from the check to said financial institution for a deduction of the amount of the transaction from said account; and
(k) converting the data transmitted and stored from the check into the computer to an ACH transaction and electronically transmitting said transaction to said financial institution for a deduction from said account of the monetary amount of the ACH transaction as defined by the amount entered into the machine for the check by the operator.

11. A method for the payment by an operator by the use of a computer system at a location remote from a billor of at least one bill issued by said billor, through the use of a check drawn on an account of a financial institution and for electronically transmitting data pertaining to the payment of the bill from said computer to at least the billor, comprising the steps of:
(a) means for advising the operator of a bill payment machine incorporating said computer, through at least one of video and audio display, that it is not necessary to fill out the amount of said check or apply a signature to said check;
(b) means for prompting the operator to introduce the check into the bill payment machine;
(c) means for optically scanning said check for retrieval of data contained on the check;
(d) means for transmitting the data retrieved from the check into the computer;
(e) means for recording an image of the check and transmitting the image into the data base of the computer for storage;
(f) means for returning the check to the operator;
(g) means for digitally recording an image of the operator and transmitting said image in said computer for storage;
(h) means for verifying the identification of the operator by optically scanning an identification document and storing predeterminable information thereon in said computer;
(i) means for prompting the operator to confirm through the machine that the operator is an authorized signor of said account identified on said check;
(j) means for electronically transmitting data from the check to said financial institution for a deduction of the amount of the transaction from said account; and
(k) means for converting the data transmitted and stored from the check into the computer to an ACH transaction and electronically transmitting said transaction to said financial institution for a deduction from said account of the monetary amount of the ACH transaction as defined by the amount entered into the machine for the check by the operator.

12. A machine for the payment by an operator by the use of a machine including a programmed computer at a location remote from a billor of at least one bill issued by said billor through the use of a check drawn on an account of a financial institution and for electronically storing and transmitting data pertaining to the payment of the bill from said computer to at least the billor, comprising:
(a) means for advising the operator of the machine incorporating said computer, through at least one of video and audio display, that it is not necessary to fill out the amount of said check or apply a signature to said check;
(b) means for prompting the operator to introduce the check into the bill payment machine;
(c) means for optically scanning said check for retrieval of data contained on the check;
(d) means for transmitting and storing the data retrieved from the check into the computer;
(e) means for recording an image of the check and transmitting the image into the data base of the computer for storage;
(f) means for prompting the operator to manually enter into the machine the monetary amount of the check;
(g) means for returning the check to the operator;
(h) means for digitally recording an image of the operator and transmitting said image to said computer for storage;
(i) means for verifying the identification of the operator by optically scanning an identification document and storing predeterminable information thereon in said computer;
(j) means for prompting the operator to confirm through the machine that the operator is an authorized signor of said account identified on said check; and
(k) means for electronically transmitting data from the check to said financial institution for a deduction of the monetary amount of the check entered into the machine by the operator.

13. An article of manufacture for use in programming a bill payment system maintaining a data base including information on processing a bill for payment therethrough, the article of manufacture comprising a computer useable storage medium having at least one computer program stored therein that causes the computer to perform the steps of:
(a) maintaining electronic information in the computer system for the operation thereof and for receipt and transmission of data pertaining to a transaction for payment of a bill;
(b) processing said electronic information to identify and sort preselected data therefrom;
(c) introducing into the computer and the electronic information data processed by the machine including: an identification of the billor; the amount of the bill; the amount of payment of the bill through the article of manufacture, defined as currency and/or check; verifying the identification of the operator if a check is used to pay all or part of the bill; receiving through a touch sensitive video screen data pertaining to payment of the bill; scanning a check for financial and source data if said check is used for all or part of the payment of the bill through the machine;
(d) electronically formatting said data for transmission to a billor;
(e) processing the payment of the bill and verifying such payment; and
(f) electronically transmitting the data pertaining to the payment of the bill to a location designated by the billor for storage within and read out on a computer system of the billor.

14. The article of manufacture of claim 12 wherein said the computer program causes a computer to perform the further step of: converting a check into an ACH transaction and electronically transmitting data pertaining to said transaction to at least a financial institution.

15. The article of manufacture of claim 12 wherein the said computer program causes the computer to perform the further step of: counting the respective denominations of currency through the article of manufacture used for payment of the bill and sorting each of denominations and computing the amount of currency in each of said denominations.
